(19) United States
(12) Patent Application Publication
(10) Pub. No.: US 2013/0204399 A1
(43) Pub. Date: Aug. 8, 2013

(54) DETERMINING AN INDICATION OF A BACKGROUND LEVEL OF UTILITY CONSUMPTION

(71) Applicants: James Donaldson, Oxford (GB); Sarah Surrall, Oxford (GB); Alexander Matthews, Oxford (GB); Malcolm McCulloch, Oxford (GB)

(72) Inventors: James Donaldson, Oxford (GB); Sarah Surrall, Oxford (GB); Alexander Matthews, Oxford (GB); Malcolm McCulloch, Oxford (GB)

(73) Assignee: Intelligent Sustainable Energy Limited, Oxford (GB)

(21) Appl. No.: 13/701,126

(22) PCT Filed: May 31, 2011
(86) PCT No.: PCT/GB2011/000832

§ 371 Date: Apr. 17, 2013

(30) Foreign Application Priority Data
Jun. 1, 2010 (GB) 1009175.9

(51) Int. Cl. G06F 17/18

(52) U.S. Cl. CPC G06F 17/18
USPC 700/12; 702/179

(57) ABSTRACT

A non-intrusive method of determining, in respect of a group of appliances that are arranged to consume a utility, an indication of a background level of consumption of the utility by the group of appliances, the method comprising: receiving a series of utility values representative of a total level of consumption of the utility by the group of appliances; determining, based on the received utility values, an indication of a background level of consumption of the utility; and outputting the determined indication of the background level of consumption of the utility.

### FIELD OF THE INVENTION

The present invention relates to a method and system for determining, in respect of a group of appliances that are arranged to consume a utility, an indication of a background level of consumption of the utility by the group of appliances.

### BACKGROUND OF HE INVENTION

For both cost and environmental reasons, consumers (be they individuals, businesses, etc.) are under increasing pressure to reduce the consumption of utilities such as electricity, water and gas.

There have been a number of technology innovations in this area, Devices such as The OWL (http://www.theowl.com/index.php?page=about-owl) display the current total electricity consumption of a site (e.g. a home or office) on a local display. Additionally, methods of so-called non-intrusive load monitoring (NILM) have been developed, which involve measuring a level of consumption of a utility by a site and then identifying which particular appliances are consuming the utility at any point in time. It is challenging for NILM systems to identify very small loads, such as a central heating timer. Examples of NILM systems are disclosed in co-pending applications GB0913312.5; GB1000695.5; GB0813143.5; PCT/GB2009/001754; GB0820812.6; GB0819763.4; GB1002896.7; U.S. Ser. No. 12/728,436, the entire disclosures of which are incorporated herein by reference.

There are many devices (e.g. a lower energy lighting system) that, when operating, have a low level of utility consumption. Accordingly, the utility consumption by such devices over a short period is small. However, a typical home or office will generally comprise a large number of such devices, many of which remain operational (or powered up) for substantial times (or even permanently). Accordingly the total level of consumption of a utility by these appliances, the so-called background level of consumption of the utility, may become significant.

Estimates of the typical background level of utility consumption of a site are varied. The International Energy Agency estimates that this accounts for 8% of residential energy consumption. However, other tests suggest that it could be much higher than this, approaching 40% in houses with large amounts of gadgets. Therefore, the ability to measure and monitor the background level of utility consumption is important when considering ways to help reduce utility consumption (with either cost or environmental impact as motivation). There are other reasons why it would be desirable to measure the background level of consumption of a utility of a site. For example, identification of a large increase in the background level of consumption of a utility may be used to identify faulty appliances e.g. a leaking tap, a faulty thermostat, or an appliance that has not been correctly shut down.

However, where a site comprises multiple appliances, performing various functions and consuming different levels of a utility, determination of the total background level of consumption of the utility is not trivial. For example, where a television and computer are in standby mode, a washing machine is operating a spin cycle, an electric kettle is boiling and an oven clock is performing its usual always-on function, it is not easy to measure which component of the total level of electricity consumed corresponds to a background level of consumption.

One possible approach is for a site manager (or home owner) to walk around the site individually measuring the background level of a utility consumed by each appliance (i.e. testing each appliance separately), such as by using a meter between an appliance's plug and mains socket. However, in order to obtain individual measurements it is necessary to either attach a monitor to each individual appliance or alternatively, to switch off all appliances other than the appliance whose consumption was being measured. Given the large number of appliances in any business or household, it is clear that neither of these approaches provide a practical method of measuring the background level of consumption of a utility. In particular, neither of these approaches is suitable for determining a background level of consumption at regular intervals and neither of them adapts to changes in the characteristics of an appliances (e.g. as an appliance ages and becomes less efficient).

Accordingly, it is an object of this invention to provide a practical method of determining an indication of the total background level of consumption of a utility by a group of appliances.

### SUMMARY OF INVENTION

The invention relates to methods of measuring background levels of utility consumption in a manner that cannot be achieved by current NILM methods and that can be performed in a convenient and easy manner (in particular by operating on the total, main input of the utility to a site instead of on an appliance-by-appliance basis).

According to an aspect of the invention, there is provided a method of determining, in respect of a group of appliances that are arranged to consume a utility, an indication of a background level of consumption of the utility by the group of appliances, the method comprising: receiving a series of utility values representative of a total level of consumption of the utility by the group of appliances; determining, based on the received utility values, an indication of a background level of consumption of the utility; and outputting the determined indication of the background level of consumption of the utility. The method may be non-intrusive, i.e. it may operate based only on readings or values indicative of the total, main input of the utility and does not rely on having to take separate readings of utility consumption by individual appliances. In particular, the method operates without requiring one or more appliances to have their own respective individual utility monitor to measure the utility usage of those appliances—for example, separate electricity usage monitor plugs are not required for the various electrical appliances in the group of appliances. In other words, the method does not need, as an input, individual utility usage values supplied from such individual appliance monitors—instead, the method may operate solely from values indicating the total level of consumption of the utility by the whole group of appliances. As such, the method is simpler to install and maintain, whilst providing an accurate estimate of the background utility usage.

In one embodiment, determining an indication of a background level of consumption comprises: clustering received utility values so as to form a plurality of clusters; identifying a cluster corresponding to the background level of consumption of the utility; and using the utility values in the identified cluster to determine the indication of the background level of consumption.

Using the utility values in the identified cluster to determine the indication of the background level of consumption may comprise determining the background level of consumption based on one of: a) an average of the utility values in the identified cluster; b) a lowest utility value in the identified cluster; or c) a greatest utility value in the identified cluster.

In one embodiment, the clusters are histogram bins.

In one embodiment, clustering comprises one of: hierarchical clustering; partitional clustering; density-based clustering; co-clustering; biclustering; k-means clustering; fuzzy c-means clustering; QT clustering; locality-sensitive hashing; graph theoretic method; and spectral clustering.

Identifying a cluster may comprise identifying a cluster from hose clusters comprising at least a predetermined number of utility values.

Identifying a cluster may comprise identifying a cluster comprising a lowest utility value or identifying a cluster comprising a largest number of utility values.

In one embodiment, determining an indication of a background level of consumption comprises: calculating a series of moving averages from the received utility values; and using the series of moving averages to determine the indication of the background level of consumption of the utility.

Calculating the series of moving averages may be biased to respond more quickly to decreases in the received utility values than to increases in received utility values.

In one embodiment, the method comprises calculating a next moving average x̅ₘ₊₁ according to x̅ₘ₊₁=(1−α) x̅ₘ+αp, where x̅ₘ is the most recently calculated moving average in the series of moving averages, p is a next received utility value and α is a value in the range 0<α<1. The method may comprise setting the value of a in dependence on the value of p, in which case this may be performed by setting

$$α = \{ \begin{matrix}{α}_{1} & if p < ( b + c ) \\ {α}_{2} & if p \geq ( b + c ) ,\end{matrix}$$

where b is a current indication of the background level of consumption and c is a predetermined value and α₁>α₂.

Using the series of moving averages to determine the indication of the background level of consumption of the utility may comprise determining the background level of consumption of the utility to be a lowest moving average value from the series of moving averages.

In one embodiment, determining an indication of a background level of consumption comprises determining a next indication of the background level of consumption based on a weighted sum of a current indication of the background level of consumption and a next received utility value.

The weighted sum may be biased to respond more quickly to decreases in the received utility values than to increases in received utility values.

In one embodiment, the weighted sum is calculated according to b_{new}=(1−α)b_{cur}+αp, where b_{new} is the next indication of the background level of consumption, b_{cur} is the current indication of the background level of consumption, p is the next received utility value and α is a value in the range 0<α<1. The value of a may be set in dependence on the value of p, in which case this may involve setting

$$α = \{ \begin{matrix}{α}_{1} & if p < ( {b}_{cur} + c ) \\ {α}_{2} & if p \geq ( {b}_{cur} + c ) ,\end{matrix}$$

where c is a predetermined value and α₁>α₂.

In one embodiment, receiving a series of utility values comprises measuring, at multiple points in time, a total level of consumption of the utility by the group of appliances.

In one embodiment, receiving a series of utility values comprises receiving utility values over a period of time, the period of time being greater than an expected duration of usage of an appliance by a user of the appliance.

The method may comprise providing a warning if the determined indication of the background level of consumption exceeds a predetermined threshold.

In one embodiment, the method comprises: using the received utility values to identify the operation of a particular appliance of the group of appliances; wherein the step of determining the indication of the background level of consumption of the utility is arranged such that the consumption of the utility by the particular appliance does not contribute to the indication of the background level of consumption of the utility.

According to an aspect of the invention, there is provided a method of controlling consumption of a utility by a group of appliances arranged to consume the utility, the method comprising: determining an indication of a background level of consumption of the utility by the group of appliances using any one of the above methods; and effecting, based on the determined indication of the background level of consumption of the utility, a change in a state of an appliance within the group of appliances so as to control a level of consumption of the utility by the appliance.

The utility may be one of: electricity; gas; oil; or water.

According to an aspect of the invention, there is provided an apparatus for determining, in respect of a group of appliances that are arranged to consume a utility, an indication of a background level of consumption of the utility by the group of appliances, the apparatus comprising a processor, wherein the processor is arranged to: receive a series of utility values representative of a total level of consumption of the utility by the group of appliances; determine, based on the received utility values, an indication of a background level of consumption of the utility; and output the determined indication of the background level of consumption of the utility. As described above, the apparatus may determine the background level indication in a non-intrusive manner.

According to an aspect of the invention, there is provided a computer program comprising computer-executable code that, when executed by a processor, causes the processor to perform any one of the above methods. The computer program may be stored on a computer-readable medium.

### BRIEF DESCRIPTION OF THE DRAWINGS

Embodiments of the invention will now be described, by way of example only, with reference to the accompanying drawings, in which:

FIG. 1 schematically illustrates a system according to an embodiment of the invention;

FIGS. 2A and 2B are graphs depicting a typical level of consumption of a utility by a site comprising a group of appliances over a background period;

FIG. 3 is a flowchart schematically illustrating a method of determining an indication of a background level of consumption of a utility by a group of appliances;

FIG. 4 is a flowchart schematically illustrating in more detail an example method for determining a background level of consumption of a utility, according to an embodiment of the invention;

FIG. 5 is an example histogram representing the frequency of received utility values over a background period; and

FIG. 6 is a flowchart schematically illustrating in more detail an example method for determining a background level of consumption of a utility, according to an embodiment of the invention.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below, it will be evident, however, that various modifications and changes may be made herein without departing from the broader spirit and scope of the invention as set forth in the appended claims.

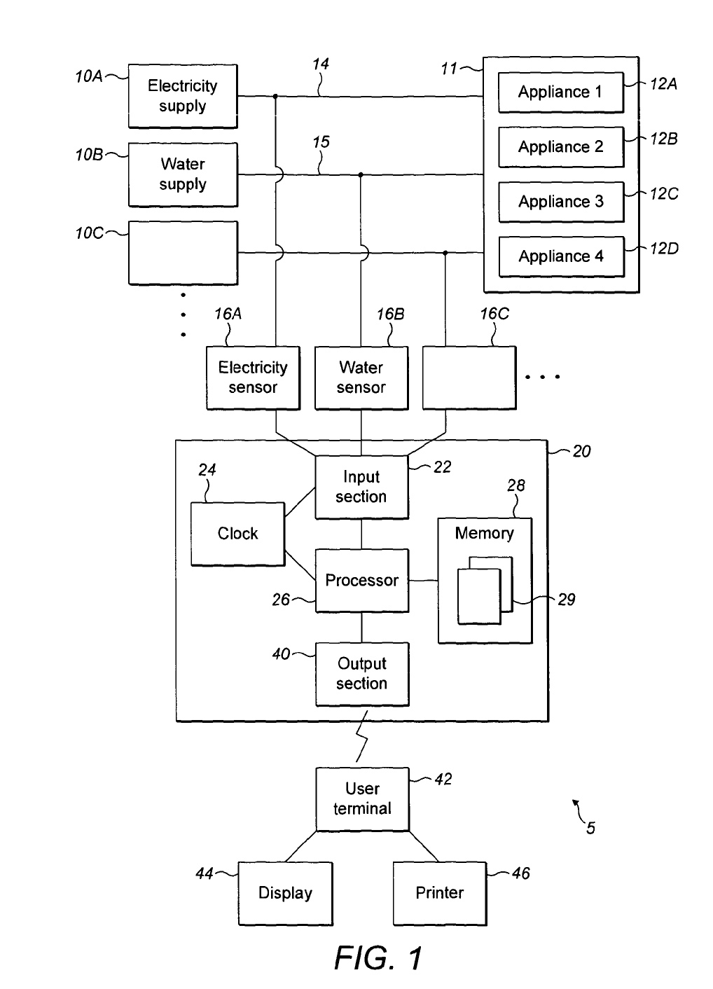

FIG. 1 schematically illustrates a system 5 according to an embodiment of the invention. The system 5 comprises a site 11, e.g. a house, apartment, office, shop, school, building, factory, etc. One or more appliances (or devices, machines, pieces of equipment) 12A, 12B, 12C, 12D . . . are located at, or form part of, the site 11. The group of appliances 12 may range from any domestic appliances (such as washing machines, refrigerators, hair dryers, etc.) to any industrial or commercial appliances. The appliances 12, in operation, are arranged to use or consume one or more utilities, such as electricity, gas (e.g. natural gas), water, oil, etc. There may be a group of appliances 12 that are arranged to consume a single utility (such as a hair dryer consuming only electricity) whereas there may be other groups of appliances 12 that are arranged to consume a plurality of utilities (such as a dish washer consuming both water and electricity).

In the system 5, an electricity supply 10A is arranged to provide electricity to one or more of the appliances 12 that are arranged to consume electricity. The electricity is supplied to these appliances 12 by means of conventional wiring 14. The appliances 12 and wiring 14 are simply shown schematically in FIG. 1, but may, of course, be configured in any appropriate way, such as via a consumer unit with circuit breakers or fuses, and with one or more ring main circuits with branches or spurs. An electricity meter (or sensor or detector) 16A is provided to measure (or sense or detect) the total instantaneous supply of electricity from the electricity supply 10A to the site 11 (i.e. to the group of appliances 12 at the site 11 that are arranged to consume electricity), or, in other words, measure the current combined (or aggregated) amount of electricity being consumed by the group of appliances 12 at the site 11.

In the system 5, a water supply 10B is arranged to provide water to one or more of the appliances 12 that are arranged to consume water. The water is supplied to these appliances 12 by means of conventional piping 15 (which may include valves, taps, etc). A water meter (or sensor or detector) 16B is provided to measure (or sense or detect) the total instantaneous supply of water from the water supply 10B to the site 11 (i.e. to the group of appliances 12 at the site 11 that are arranged to consume water), or, in other words, measure the current combined (or aggregated) amount of water being consumed by the group of appliances 12 at the site 11.

Some appliances 12 may additionally or alternatively be connected to the supply of other utilities 10C, 10D, . . . . Corresponding utility meters 16C, 16D, . . . are provided to detect the overall utility usage of each utility 10C, 10D, . . . by the appliances 12 at the site 11.

The electricity meter 16A may be arranged to measure the current being provided to (or consumed by) the appliances 12 from the supply 10A. The current may be measured by any suitable sensor, for example a current clamp placed around one of the conductors of the electricity supply wiring 14. The current clamp typically comprises a magnetisable material, such as ferrite, which forms a magnetic circuit around the conductor, and acts as a transformer to induce a voltage in a secondary winding around the magnetisable material, from which an indication of the current flowing in the supply wiring 14 can be obtained. As an alternative to this current-transformer, a Hall-effect sensor can be used to measure the magnetic field in the loop of magnetisable material around the wire which is related to the current flowing through the wire. Other suitable ways may, of course, be used for sensing the current.

Additionally, or alternatively, the electricity meter 16A may be arranged to measure the instantaneous voltage of the electricity supply 10A. The voltage of the electricity supply may be measured by any suitable volt meter. This, of course, typically requires access to two of the conductors in the wiring 14. This can be achieved, for example, by probes which strap around the respective cables and have spikes which penetrate the insulation to make contact with the conductor. Alternatively, connections could be made to terminals in the consumer unit, or, for example, at a location where fuses or circuit breakers are insertable. Non-invasive capacitive voltage detectors could also be used.

The water meter 16B may be arranged to measure the flow (or consumption or supply) of water to the appliances 12 from the water supply 10B using any known technique of detecting the rate of supply of water through one or more water supply pipes 15 servicing the site 11. Similarly, the other meters 16C, 16D, . . . may be arranged to measure the total instantaneous supply of their respective utility to the site 11 via any corresponding known techniques.

It will be appreciated that different embodiments may relate to some or all of the utility supplies 10A, 10B, 10C—e.g. some may relate to only monitoring/analysing electricity supply values, some may relate to only monitoring/analysing water supply values, some may relate to only monitoring/analysing gas supply values, whilst some may relate to monitoring/analysing supply values of different combinations of utilities. Consequently, in some embodiments, some of the utilities meters 16A, 16B, 16C, . . . may be omitted, depending on which particularly utility (or utilities) are to be monitored.

As shown in FIG. 1, the utility meters 16 are connected to a monitoring apparatus 20. It is, of course, possible that some or all of the utility meters 16 are incorporated within the apparatus 20, for example that wires connect the supply wiring 14 to the apparatus 20, and the current and/or voltage of the electricity supply 10A is measured within the apparatus 20. Alternatively, in a different embodiment, one or more of the utility meters 16 may be self-contained and may communicate with the apparatus 20 wirelessly and/or via a communication cable connecting a utility meter 16 with the apparatus 20, e.g. by sending analogue or digital values of the instantaneous current and instantaneous voltage. In one embodiment, the apparatus 20 can derive its own power supply by virtue of being connected to a portion of the electricity meter 16A. In one particular form of this, the apparatus 20 is simply plugged into an electrical outlet in the same way as an appliance 12 to obtain its power supply and also to measure the supply voltage and/or current. However, in the preferred embodiment, the apparatus 20 and utility meters 16 are conveniently located near where the supplied utilities enter the site 11, such as near where the conventional electricity meter is or would be located. In any case, the apparatus 20 receives utility values representative of a total level of consumption of the utility by the appliances 12.

The apparatus 20 comprises a number of different units, namely an input section 22, a clock 24, a processor 26, a store or memory 28, and an output section 40. It is possible to implement each of the various units as dedicated hard-wired electronic circuits; however the various units do not have to be separate from each other, and some or all could be integrated onto a single electronic chip such as an Application Specific Integrated Circuit (ASIC) or Field Programmable Gate Array (FPGA) or Digital Signal Processor (DSP) device. Furthermore, the units can be embodied as a combination of hardware and software, and the software can be executed by any suitable general-purpose microprocessor, such that in one embodiment the apparatus 20 could be a conventional personal computer (PC). The software would take the form of one or more computer programs having computer instructions which, when executed by a processor (e.g. the processor 26) carry out a method according to an embodiment of the present invention as discussed below. The computer programs may be stored on a computer-readable storage medium, such as a magnetic disc, optical disc (e.g. a CD or DVD), the memory 28, etc.

When the apparatus is arranged to monitor electricity, the input section 22 of the apparatus 20 receives current and/or voltage values from the electricity meter 16A. The values are input or measured preferably multiple times per cycle of the alternating electricity supply to a level of accuracy as required by the application. If the values are supplied as analogue voltages, then the input section 22 may comprise, for example, an analogue to digital converter, such that the rest of the apparatus 20 can be implemented using digital electronics. When the apparatus is arranged to monitor water, the input section 22 of the apparatus 20 receives values representative of use of water (e.g. water flow rate measurements or water pressure measurements) from the water meter 16B. Similarly, other values may be provided to the input section 22 by the other utility meters 16C, 16D, . . . (e.g. other utility flow rate measurements such as oil or gas flow rate measurements, or other utility pressure measurements such as oil or gas pressure measurements) when the apparatus is arranged to monitor those other utilities. In general, then, the input section 22 of the apparatus 20 acts as an interface that is arranged to receive (or derive or obtain) a series of utility values representative of a total level of consumption of the utility by the appliances 12. The input section 22 could form part of the processor 26.

The input section 22 also receives time data from the clock 24. The time data may represent the actual present time, a time local to the apparatus 20, or some other timing values. The time data supplied to the input section 22 could simply be a synchronisation pulse. The input section 22 may use the time data received from the clock 24 to determine when to output data values to the processor 26 and/or when to sample the inputs that it receives from the utility meters 16.

The clock 24 could, of course, be integral with other components of the apparatus 20, or the apparatus 20 could receive a clock signal from an external source such as a transmitter broadcasting time data. In one preferred embodiment the clock 24 comprises a quartz oscillator together with other timer circuitry that is an integral part of the processor 26 (described below). In this case, the input section 22 for receiving the time data is also an integral part of processor 26.

The processor 26 receives (or derives or obtains), from the input section 22, a series of utility values representative of a total level of consumption of the utility by the appliances 12 and performs a number of different functions as shall be described in more detail below.

The memory 28 may be any kind of memory for storing information. The memory 28 may comprise a non-volatile memory and/or a volatile memory and may comprise one or more of a magnetic disc, an optical disc, a solid-state memory, a FLASH memory, an IC-card device, a read-only-memory or a random-access-memory. The memory 28 may store one or more computer programs 29 which, when executed by the processor 26, carry out embodiments of the invention. The processor 26 may write data to (i.e. store data in) the memory 28 and/or read data from the memory 28 as part of its processing operations.

The processor 26 receives data from the input section 22 and possibly the memory 28 and possibly the clock 24. The processor 26 could be a general purpose processing device or could be a digital signal processor or could be a bespoke hardware device (e.g. FPGA or ASIC) manufactured specifically for implementing one or more embodiments of the invention. The processor 26 may store some or all of the data received from the input section 22 in the memory 28. The processor 26 then performs various processing/analysis steps which are described in detail below.

Following the processing/analysis, the processor 26 produces information regarding utility utilisation for some or all of the appliances 12. This information may be transmitted directly to the utility provider. Alternatively, this information may be output by the output section 40 to a user terminal 42 (such as a PC or a dedicated device for utility-use feedback) so that the information can be conveniently presented to the user. The user terminal 42 can be a standard desktop or laptop computer with an attached monitor/display 44 and/or printer 46, or can be a dedicated device. The user terminal 42 may comprise its own processor (not shown) for processing data (e.g. data received from the apparatus 20 and/or as an input from a user). Alternatively, the output section 40 may output the information directly to a person (e.g. visually when the output section 40 comprises a screen/display and/or audibly when the output section 40 comprises a speaker)—in this case the user terminal 42, display 44 and printer 46 may be omitted.

In some embodiments, it is the processor of the user terminal 42 (independent of or in conjunction with the processor 26 of the apparatus 20) that carries out the utility consumption processing/analysis that shall be described later.

Although the apparatus 20 and the user terminal 42 are shown as separate devices in FIG. 1, they could, of course, be part of the same device. The output section 40 in the preferred embodiment communicates wirelessly, for example by radio frequencies (RF) link, or optically, or by infrared, or acoustically. The output section 40 may be arranged to communicate via a network (be that wirelessly or via a wired network). It is also possible that the communication with the user terminal 42 is done through the supply wiring 14 if the user terminal 42 is plugged into one of the supply outlets of the site 11 as an appliance 12.

In a further embodiment, the output section 40 can also act as a receiver, such that communication between the apparatus 20 and user terminal 42 is two-way. This enables the user terminal 42 to be used as a further means for updating the apparatus 20 (e.g. to update the computer programs 29 stored in the memory 28).

The description that follows shall focus on the case in which the utility is electricity, but it will be appreciated that the description applies analogously to the other utilities (in isolation or in combination).

Each appliance 12 in the site 11 is able to perform one or more functions, i.e. carry out one or more actions, tasks or operations. An appliance may be able to perform multiple functions at the same time—for example, a cooker may have an oven, a grill, one or more hobs, a clock, etc. which can all be used simultaneously. An appliance may be able to perform only one function at any given time—for example a toaster may be limited to only ever performing its toasting operation, whilst a combination fax-printer-scanner may be able to perform only one of the operations of faxing, printing and scanning at any given time. At any point in time, an appliance 12 may be performing no functions at all, for example if it is switched off (i.e. turned off, powered down or shut down) or is no longer in use or is simply waiting to be switched on.

When a function is being performed by an appliance 12, the level of usage of a utility, and the total consumption of the utility, by that appliance 12 will depend on the nature of the function being performed. Consequently, as the total consumption of a utility by the site 11 is the sum of the utility consumptions by the various appliances 12 at the site 11, the total consumption of the utility by the site 11 will depend on the nature of the function(s) that are being performed at any one particular time across the various appliances 12. For example:
One function of an appliance 12 may be the so-called “standby” function, also known as “sleep” function, “low power mode”, or “suspended mode”. An appliance 12 carrying out the standby function usually does not carry out any other functions at that time. In particular, carrying out the standby function places the appliance 12 in an “idle” state in which the appliance 12 retains its various settings (e.g. as data stored in a memory) but does not perform any other function. As such, an appliance 12 that is carrying out the standby function may be considered to be operating in a state between being switched-off and fully switched-on, i.e. the appliance 12 is not being used to perform its main functionality, but a user may resume use of the appliance 12 without having to re-boot the appliance 12 or re-program the appliance settings (since the appliance settings have been retained during the standby function). Many appliances 12, such as televisions and personal computers, make use of a standby function as it provides a level of power saving, i.e. the usage of electricity is kept to a minimum but the appliance 12 remains in a ready-to-use state.
A function may be considered to be a primary function (or one of the primary functions) of the appliance 12, in that that function is one of the main purposes/tasks/roles of the appliance 12. For example, a combination microwave oven may be able to act as a microwave, a conventional convection oven and a grill, in which case the primary functions of this appliance 12 are: performing microwaving; acting as a convection oven; performing a grilling operation. Similarly, a function may be considered to be a secondary function (or one of the secondary functions) of the appliance 12, in that that function is not one of the main purposes of the appliance 12. For example, the combination microwave oven may have a digital clock display, in which case the secondary function of this appliance 12 is a “clock” or “timer” function. Often, the utility consumption involved in performing a primary function will be greater than that involved in performing a secondary function. The standby function may be viewed as a secondary function.
Performing a function may involve consuming a utility at a substantially fixed rate—examples include the standby function, a television display function, a clock function, etc. Performing other functions may involve consuming a utility at a substantially varying rate—examples include operating a dimmer switch or running a motor in a washing machine.
Some functions may be performed for limited (or short) durations which may be definite/specific periods of time, e.g. a period of time necessary to perform a specific task. For example, a kettle performs its “boiling” function for a duration necessary to boil the water in the kettle (which will be dependent on the current amount and temperature of the water); a dish washer or a washing machine will performing its “washing” function for the fixed period of time required to complete a chosen washing cycle/routine. A limited duration function may be performed simply for the amount of time a user wishes the appliance 12 to perform that function (e.g. for an amount of time a user interacts with the appliance 12). For example, a television may perform its “picture display” function for as long as a user wishes to watch the television.
Some functions may be performed for prolonged (substantial) periods or even permanently (or at least substantially permanently). Functions performed in this manner may be referred to as always-on functions. For example, a broadband router may perform its “routing” function continuously (i.e. as long as the router is connected to the power supply) even when not being directly used by a user, as it may perform various polling/monitoring actions; a digital clock will constantly display the time whilst it is connected to a power supply; a leaking tap will continue to drip water for an indefinite period until the leak has been fixed etc. Always-on functions may be viewed as those actions that are performed for durations longer than one would expect a human user to interact with an appliance 12.

Of course, an appliance 12 may be arranged to perform different mixes of these types of function. For example, a refrigerator will make use of an always-on function of monitoring the temperature in a refrigeration chamber, and will make use of a limited duration function (namely operation of a compressor etc.) to cool the refrigeration chamber when this is deemed necessary.

Embodiments of the invention are concerned with determining an indication or estimate of a background level of consumption of a utility by the appliances 12 at a site 11, i.e. a baseline amount or degree of usage of the utility by the appliances 12 at the site 11. The term “background level” shall be described in more detail shortly. However, the background level corresponds to a period of time of interest (i.e. a length of time or a measurement/analysis window), which shall be referred to as the “background period”. The background period may be a contiguous period of time (e.g. the most recent 24 or 48 hour period) or may be non-contiguous (e.g. the period of time defined by the working hours of an office, such as the combined periods of 9 am to 5 pm Monday to Friday of a particular week). The background period is usually substantially longer than the expected period of time with which a human being would interact with an appliance—for example, a human being may watch a television for a couple of hours, so the background period may be in the order of tens of hours long. If one were to assume that a human being only interacts with an appliance for up to 1 hour, then a suitable background period could be around 6 to 12 hours long. However, this will, of course, depend on the particular appliances 12 and the nature of the site 11 (e.g. domestic vs industrial vs commercial).

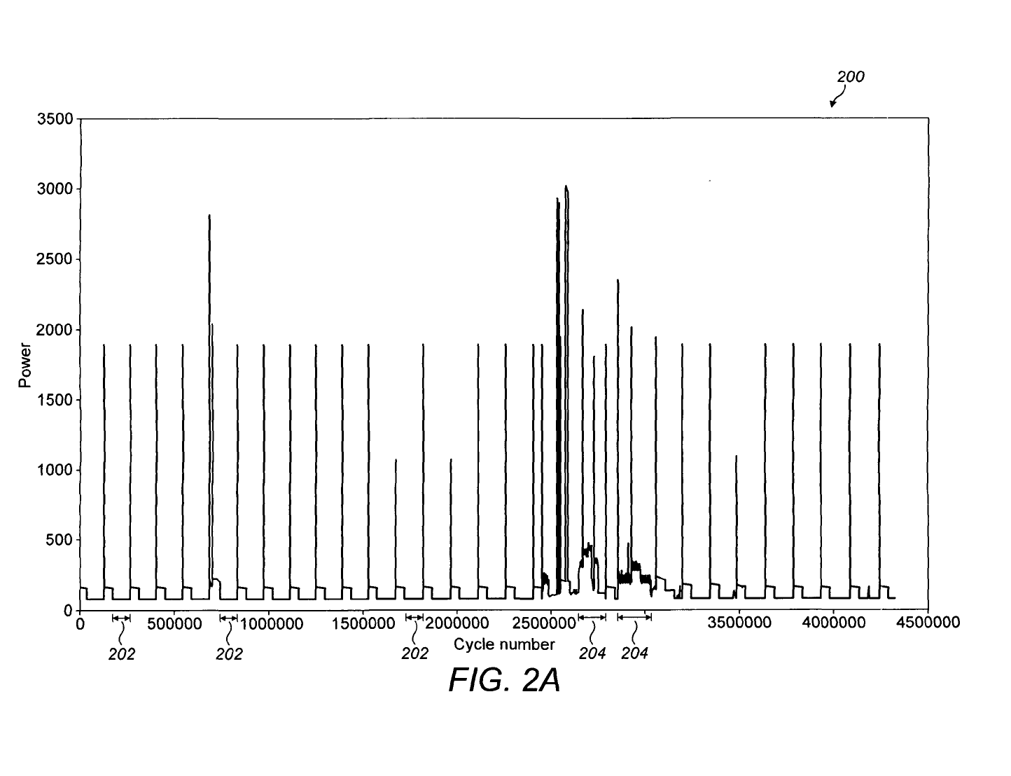

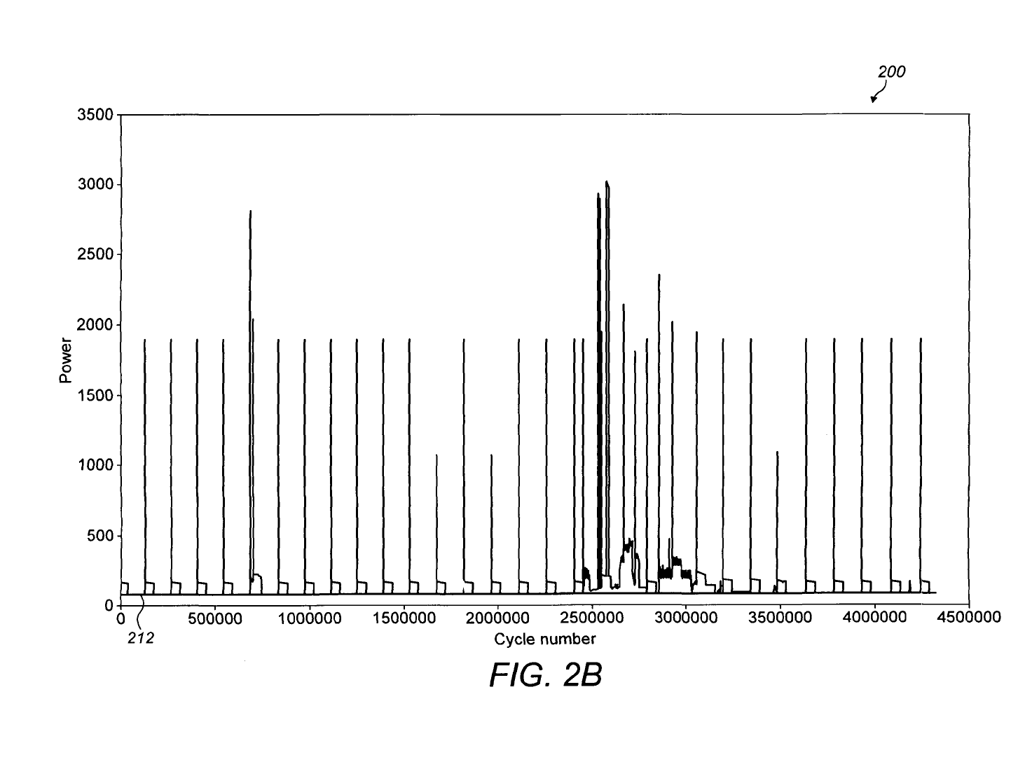

FIG. 2A is a graph 200 depicting a typical level of consumption of a utility by a site 11 comprising a group of appliances 12 over a background period (in this example the background period is 48 hours, with the utility consumption being measured at 25 Hz). The level of consumption of the utility varies throughout the background period in accordance with the appliances 12 performing zero, one or more of their associated functions (as described above). It can be seen that the level of consumption of the utility is steady (or substantially constant) for some sub-periods 202 of the background period. It can also be seen that for some sub-periods 204 of the background period the level of consumption of the utility is non-steady (i.e. substantially varying or transient).

For any given level L of consumption of the utility, the site 11 will have been consuming the utility at substantially that level (e.g. at a level between L−δ and L+δ for some value δ) for a proportion p_{L} of the background period (which may be as consumption at that level over a single contiguous period of time or over a combination of separate periods of time). The background level of utility usage may be viewed as the lowest level L of consumption of the utility for which p_{L} is greater than some threshold value T, i.e. the lowest level of utility usage that is substantially attained/maintained for at least a significant/given/threshold portion of the background period. Levels of consumption lower than this background level may simply be due to noise in measurements etc. and may not be representative of the true baseline level of utility consumption at the site 11. FIG. 2B is the same graph 200 as shown in FIG. 2A but with a possible background level of consumption indicated by a line 212. It will be appreciated that differences in the choice of the threshold value T and/or what is meant by “‘substantially’ at a level for some proportion p_{L} of the background period” (e.g. the choice of δ) may result in a different definition of the background level of consumption.

The background level of consumption of the utility by the site 11 may therefore be viewed as the lowest quasi-constant level of utility consumption achieved by the site 11 over the background period.

The background level of consumption of a utility by the site 11 may be viewed another way. The site 11 may be said to be in a steady-state when the level of utility consumption remains substantially constant for at least a threshold contiguous period of time—a steady-state therefore has an associated level of utility usage. A site 11 will be in a steady-state if the various appliances 12 remain performing the same function(s) over a threshold period of time T. Steady-states may be viewed as the site 11 being in a stable, reproducible condition. Between being in steady-states, the site will be in transition-states, during which the utility consumption is varying or, at the very least, is not sufficiently steady for sufficiently long. The sub-periods 202 shown in FIG. 2A are examples of periods during which the site 11 is in respective steady-states; the sub-periods 204 shown in FIG. 2A are examples of periods during which the site 11 is in respective transition-states. The background level of utility usage may be viewed as the lowest of the levels of utility usage associated with the steady-states that occurred during the background period. It will be appreciated that the meaning of a “steady-state” will depend on the threshold value T as well as what is meant by “‘substantially’ constant for at least a threshold contiguous period of time” and therefore differences in the choice of the threshold value T and/or what is meant by “‘substantially’ constant for at least a threshold contiguous period of time” may result in a different definition of the background level of consumption.

The background level of consumption of the utility by the site 11 may correspond to the level of consumption of the utility by the appliances 12 that are performing the standby function (or possibly secondary functions too) and/or that are performing always-on functions. Such appliances 12 may be referred to as a background loads (vampire load/vampire draw/phantom load). These background loads may be viewed as having a quasi-constant utility consumption over a period of time that is long relative to the expected duration of usage of the appliances 12 by users.

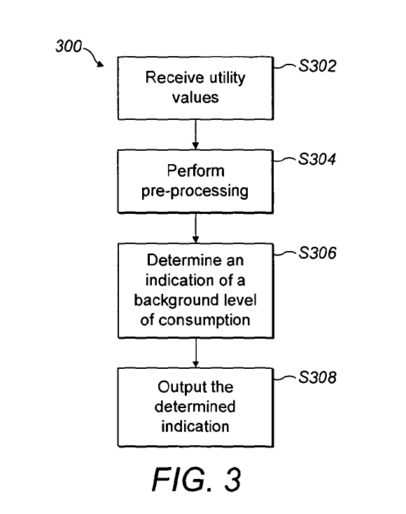

FIG. 3 is a flowchart schematically illustrating a method 300 of determining an indication of a background level of consumption of a utility by a group of appliances. As discussed above, the method 300 may be performed by the processor 26 (for example by a general purpose processor executing a computer program 29, or by a dedicated hardware device).

At a step S302 of the method 300 the processor 26 receives, from the input section 22, a series/sequence of utility values (consumption data) representative or indicative of a total level or amount of usage (consumption) of a utility by the group of appliances 12. The input section 22 may receive the utility values from one or more of the meters 16. As discussed above with reference to FIG. 1, the meters 16 may be part of the input section 22 in which case the step S302 may comprise measuring the utility values. Also as discussed with reference to FIG. 1, the input section 22 may be part of the processor 26 in which case the processor 26 may receive the utility values directly from one or more of the meters 16.

In general, then, at the step S302 the processor 26 receives (or derives or obtains) a series of utility values representative of a level of consumption of the utility by the appliances 12 over time. The received utility values may be stored in the memory 28. For this, a last-in-first-out (or cyclic) buffer arrangement could be used so that utility values corresponding to the current background period (e.g. the most recent 48 hours) are stored, with utilities values that were measured before the start of the current background period being removed from (replaced in) the buffer.

At a step S304 of the method 300 the processor 26 performs any pre-processing of the received utility values that may be desired/required in order to carry out the subsequent steps of the method 300. For example, if the utility values are supplied as analogue values, then at the step S304 the processor 26 may convert the received analogue values to digital values such that the rest of the method 300 can be implemented based on digital values. Additionally or alternatively, at the step S304 the processor 26 may filter the received values, e.g. by filtering out noise. Additionally or alternatively, the processor 26 may convert the received utility values from their current format and/or unit of measurement to a more suitable format and/or unit of measurement. For example, the received utility values may represent voltage and current measurements, and the processor 26 may convert these measurements into real and/or reactive power values, as such values may be more convenient (or even required) for the subsequent processing. In a preferred embodiment in which electricity is the utility in question, the utility values are real power values (which may be calculated from received voltage and current values), although reactive power could be used in addition or as an alternative.

The step S304 is optional as pre-processing of the received utility values may not be required. Additionally or alternatively, the step S304 may be performed as part of the step S302. For example the input section 22 may pre-processes the received utility values by rejecting utility values received during certain time periods (e.g. if the background period is the combined periods of 9 am to 5 pm Monday to Friday of a particular week, then the input section 22 may ignore any values received outside this period). Additionally or alternatively, the step S304 may be performed before the step S302 so that the values received at the step S302 have already been pre-processed. Accordingly, in what follows any reference to the received values (i.e. the values received at the step S302) may equally mean the pre-processed values (i.e. the values generated at the step S304).

At a step S306 of the method 300 the processor 26 determines, based on the received utility values, an indication (or estimate or approximation) of a background level of consumption of the utility by the appliances 12. The determined indication may comprise a value (e.g. the actual determined background level), a range of values or any possible indication of a degree of background consumption of the utility (e.g. one of “very low”, “low”, “medium”, “high”, “very high”). Examples of how the processor 26 may determine an indication of a background level of consumption of the utility will be discussed later.

At a step S308 of the method 300 the processor 26 outputs the determined indication of the background level of consumption, e.g. to the memory 28 for storage or to the output section 40 for subsequent output/communication (e.g. to the user terminal 42), which could be for display to a user or for further analysis of utility consumption.

It will be appreciated that the steps S302-S308 may be implemented by any suitable arrangement, e.g. sequentially, in parallel, by pipeline operation etc. It will also be appreciated that the steps S306 and S308 may be performed at the same frequency as performing the step S302 (and possibly the optional step S304 too). For example the processor 26 may receive utility measurements at a frequency of 50 Hz and the processor 26 may then calculate an indication of the background level at the same frequency. Additionally or alternatively, the steps S306 and S308 need not be performed every time a utility value is received at the step S302. Instead, for example, the steps S306 and S308 may be performed periodically, with a plurality of utility values being received at the step S302 between each determination of the background level indication. This may be preferred in embodiments in which the calculation of background level indication is processor-intensive. Additionally, as the background level of consumption relates to more slowly varying trends, there is no significant downside to such periodic calculation.

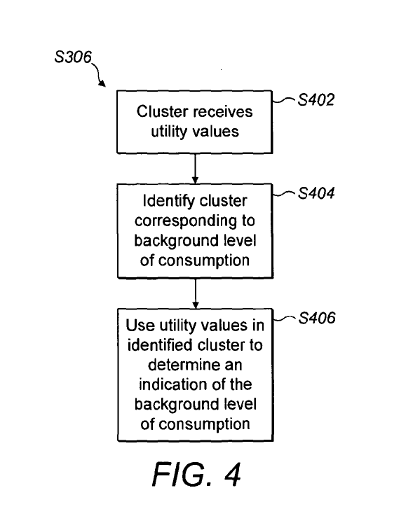

FIG. 4 is a flowchart schematically illustrating in more detail an example method for determining a background level of consumption of a utility at the step S306 of the method 300 of FIG. 3, according to an embodiment of the invention.

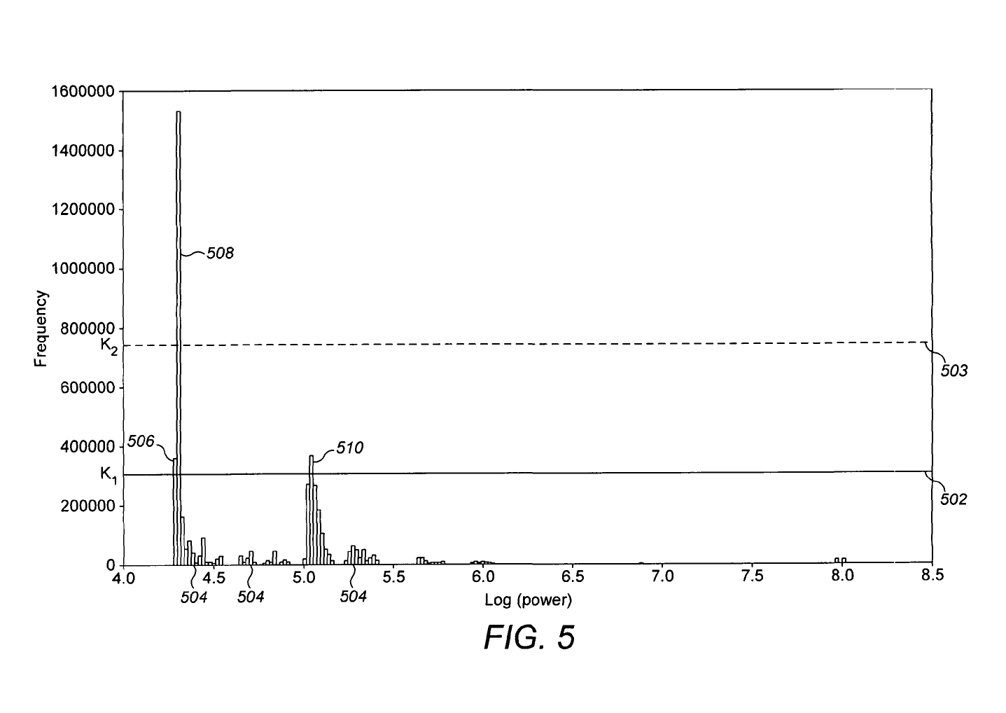

At a step S402 the processor 26 clusters or groups (i.e. assigns or allocates into subsets, groups or clusters) the stored received utility values that correspond to the current background period so as to form a plurality of clusters. For example, as shown in FIG. 5, the clusters formed by the processor 26 may correspond to histogram bins, i.e. each cluster contains all of the received values that lie in a range of values corresponding to that histogram bin. The values in a cluster are similar values (e.g. numerically close to each other). In FIG. 5, the histogram bins are shown as uniformly sized in the log(power) domain. As such, the preprocessing step S304 could involve determining log(power) values from received current and voltage utility values, so that the histogram bins (i.e. the clusters) are based on uniformly sized ranges of values; alternatively, the preprocessing step S304 may not determine log(power) values and the step S306 may operate on power values directly, in which case the histogram bins may be non-uniformly sized ranges of values. It will be appreciated, though, that this is merely one example of forming a histogram of received utility values and that other arrangements of histogram bins could be used instead.

At a step S404 the processor 26 identifies a cluster corresponding to the background level of consumption of the utility.

The processor 26 may identify a cluster corresponding to the background level of consumption from just those clusters that comprise at least a predetermined number of utility values. For example, as shown in FIG. 5 the processor 26 may use a predetermined threshold K (shown as line 502 or dashed line 503) on the number of utility values in a cluster; a cluster will be considered as a candidate for determining the background level of utility consumption if it contains at least K utility values. In FIG. 5, bins 504 are example bins that comprise fewer values than the threshold number 502 of utility values, and as such the processor 26 may ignore these bins 504 when determining the background level of utility consumption. In contrast, bins 506, 508 and 510 are bins that comprise at least the threshold number 502 of utility values, and as such the processor 26 considers these bins when determining the background level of utility consumption. As can be seen, if a different threshold 503 were used, then different bins (only the bin 508 in this case) would be considered when determining the background level of utility consumption. The use of the threshold 502, 503 enables clusters that correspond to noisy values to be ignored. However, the use of such a threshold 502, 503 is optional and, for embodiments of the invention that do not make use of such threshold 502, 503, all clusters may be considered by the processor when determining the background level of utility consumption.

From the clusters under consideration, the processor 26 may use any relevant criteria to identify a cluster corresponding to the background level of consumption. For example, the processor 26 may identify any of the following clusters as the cluster corresponding to the background level of consumption, namely: the cluster comprising a lowest received utility value; the cluster comprising the largest number of utility values; some (possibly weighted) combination of these criteria; etc. For example, with the scenario shown in FIG. 5a the processor 26 may identify the bin 506 as corresponding to the background level of consumption as it comprises the lowest utility value out of the various bins under consideration (i.e. those bins comprising more than the threshold number 502 of utility values). If the threshold number 503 were being used instead, then the processor 26 may identify the bin 508 as corresponding to the background level of consumption.

In general then, at the step S404 the processor 26 identifies (selects or determines), from the clusters, a cluster corresponding to the background level of consumption of the utility by the group of appliances 12.

At a step S406 the processor 26 uses the utility values in the identified cluster to determine the background level of consumption of the utility. For example, the processor 26 may determine the indication of the background level to be an average of the utility values in identified cluster (e.g. the mode, mean, median etc), and this could be a weighted average; the lowest utility value in the identified cluster; the largest utility value in the identified cluster; the range of utility values in the identified cluster; etc.

It will be appreciated that whilst the above description uses the example of histogram clustering, the processor 26 may perform the steps S402-S406 in accordance with any possible clustering method (scheme/rule) e.g. hierarchical clustering; partitional clustering; density-based clustering; two-way cluster (co-clustering, biclustering); k-means clustering; fuzzy c-means clustering; QT clustering; locality-sensitive hashing; graph theoretic method; spectral clustering; etc. Additionally, the above example is based on one-dimensional clustering (i.e. clustering of power values). In other embodiments, multi-dimensional clustering could be used instead, e.g. clustering in a two-dimensional space based on (real-power, reactive-power) pairs, when the received utility values are converted into such pairings (e.g. at the step S304).

One advantage of the above clustering approach is that information from the entire duration of the background period can be taken into account, even if the times at which the background level of utility usage is being achieved are each relatively small and separated over the background period.

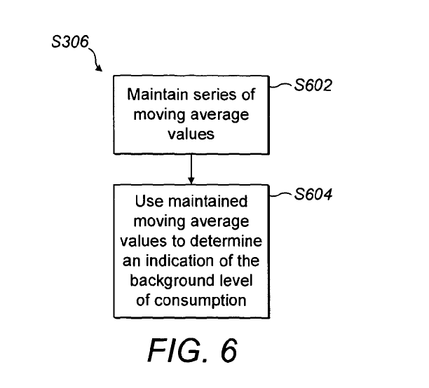

FIG. 6 is a flowchart illustrating in more detail an example method for determining a background level of consumption of a utility at the step S306 of the method 300 of FIG. 3, according to an embodiment of the invention.

At a step S602 the processor 26 maintains or calculates a series of moving averages (rolling averages, rolling means, running averages) of the received utility values. It will be appreciated that the processor 26 may already have determined the series of moving average values at the pre-processing step S304 of the method 300 (i.e. the step S602 may be part of the step S304).

Assuming that there are n moving averages x̅₁, . . . , x̅ₙ that are to be maintained (for example by storing and updating them in a buffer in the memory 28) then moving average x̅ₙ represents an average (which may be a mean) of a group of most recently received utility values. The preceding moving average x̅ₙ₋₁ represents an average (again which may be a mean) of a group of utility values less recently received than those used for the moving average x̅ₙ. The group of utility values used for the moving average x̅ₙ and the group of utility values used for the moving average x̅ₙ₋₁ may overlap or may be disjoint sets of utility values. The same then applies mutatis mutandis down the series of moving averages x̅ₙ₋₂, x̅ₙ₋₃, . . . , x̅₁. When a new moving average is calculated (because more recent utility values have now been received at the step S302), then the oldest moving average x̅₁ may be discarded. In particular, when this process is initialising (so that not many moving average values have been calculated yet), then the series of moving averages may not yet correspond to the length of the background period; however, once the series of moving averages has been established and now is derived from utility values taken over a complete background period, then the “oldest” moving average may be discarded when a new moving average is calculated, as the oldest moving average may no longer correspond (or be derived from) the latest background period.

In one example, if the series of received utility values is (xⱼ), then a moving average x̅ₘ may be calculated as

$${\overline{x}}_{m} = \frac{1}{R} {\sum }_{j = ( m - 1 ) L + 1}^{( m - 1 ) L + R} {x}_{j} ,$$

for some positive integer R that represents the number of sample utility values that are used to calculate a moving average value and for some positive integer L that controls a degree of overlap of the groups of sample utility values that are used for consecutive moving average values. For example, if L=1, then the groups of sample utility values that are used for consecutive moving average values will differ in only 1 utility value, whereas if L=R then the two groups do not overlap at all. Of course, there is no need for the value of R and/or L to be constant across the series of moving averages.

The above method of calculating the moving averages requires the processor 26 to store, in the memory 28, at least some of the received utility values pᵢ. To avoid this (for example if the amount of memory 28 is limited) the processor 26 may estimate a next moving average x̅ₘ₊₁ and use this estimate as the value for the next moving average x̅ₘ₊₁ according to x̅ₘ₊₁=(1−α) x̅ₘ+αp where p is the next received utility value and α is a predetermined value in the range 0<α<1.

At a step S604, the processor 26 may use the current set of calculated moving averages x̅ₖ, . . . , x̅ₖ₊ₙ₋₁ to determine an indication of the background level of consumption b. One way of doing this is to set b equal to the minimum of the current set of calculated moving averages x̅ₖ, . . . , x̅ₖ₊ₙ₋₁ although other ways maybe used (e.g. a weighted average of a number of the lowest moving averages x̅ₖ, . . . , x̅ₖ₊ₙ₋₁, with the weighting biased towards lower valued moving averages).

As mentioned above, a next moving average x̅ₘ₊₁, may be determined (or estimated) according to x̅ₘ₊₁=(1−α) x̅ₘ+αp where p is the next received utility value and α is a predetermined value in the range 0<α<1. However, in some embodiments, α may be a function of p. For example, the value of α may increase as p decreases, so that smaller received utility values contribute more to the moving average values than larger received utility values, thereby keeping the estimated background level of utility consumption lower and less affected by spikes in the utility usage. Alternatively, in one embodiment, α is a function of both p and b (the most recently determined background level of utility consumption). In particular, if the received utility value p is less than (b+c) for some constant c, then the processor 26 may use a first value of α=α₁; whereas if the received utility value p is greater than (b+c), then the processor 26 may use a second value of α=α₂, where α₁>α₂. Example values for α₁ and α₂ are 5×10⁻² and 5×10⁻⁸ respectively. In one embodiment, c is 0 so that it can therefore be ignored. It will be appreciated that these methods of selecting the value a allows the moving average values to be modified/controlled in order to improve the determined indication of the background level of consumption. In particular, these methods for selecting α means that the determined indication of background level of consumption decreases much more quickly than it increases, so that the determined indication will more quickly reflect a minimum level of consumption of a utility (hence the choice of α₁>α₂). The value of a (or α₁ or α₂) may be chosen such that when the received utility values indicates a large increase in consumption of a utility the determined background level of consumption will only reflect the increase after the increased level of consumption has been maintained for a significant period. For example, where a heater is turned on causing a spike in gas consumption, a value α may be chosen so that the determined background level of gas consumption only reflects the level of consumption by the heater if the heater remains switched on for a number of hours. This manipulation of the determined indication of the background level of consumption through selection of a suitable value for α (or α₁ or α₂) means that increases in the level of consumption which do not last for a significant period (relative to the measurement or background period) will not incorrectly lead to an increase in the determined indication of the background level of consumption.

In one embodiment, the value of n (i.e. the number of moving averages in the maintained series of moving averages) may be equal to 1. In this case, the determination of the indication of the background level of consumption comprises determining a next indication of the background level of consumption based on a weighted sum of a current indication of the background level of consumption and a next received utility value. The above equations then amount to calculating b_{new}=(1−α)b_{bur}+αp, where b_{new} is the next indication of the background level of consumption, b_{cur} is the current indication of the background level of consumption, p is the next received utility value and α is a value in the range 0<α<1. The weighting may be biased to respond more quickly to decreases in the received utility values than to increases in received utility values. In particular, the value of α may be set in dependence on the value of p, such as

$$α = \{ \begin{matrix}{α}_{1} & if p < ( {b}_{cur} + c ) \\ {α}_{2} & if p \geq ( {b}_{cur} + c ) ,\end{matrix}$$

where c is a predetermined value and α₁>α₂. These embodiments are therefore similar to the above embodiment using the series of moving averages, and may be seen as the “boundary” case where the series of moving averages involves a series of length 1.

One advantage of this method of using moving averages (as described above with reference to FIG. 6) in comparison to the method of using clustering (as described above with reference to FIG. 4) is that the amount of data that needs to be stored is much less. In particular, the method of FIG. 6 needs only to maintain a list of moving average values; in contrast, the method of FIG. 4 generally stores a much larger data set of received utility values.

In one embodiment, the processor 26 may analyse the received utility values so as to deduce which household appliances are being used at a particular time, as well as the individual level of consumption of each appliance. The processor 26 may use any suitable method to perform this analysis and deduction, for example the processor 26 may use a method (or any combination of methods) as set out in co-pending applications GB0913312.5; GB1000695.5; GB0813143.5; PCT/GB2009/001754; GB0820812.6; GB0819763.4; GB1002896.7; U.S. Ser. No. 12/728,436 which are incorporated by reference herein. The processor 26 may use this information regarding which appliances are being used when determining the background level of consumption. For example, the processor 26 may detect that a television has been turned on and accordingly may discount the energy consumption of the television when determining the background level of consumption. A list of appliances (or maybe even a list of functions performed by appliances) not considered to contribute to the background level of consumption may be stored in the memory 28. Having detected that an appliance is performing a function (e.g. the television has been turned on to be watched by a user), the processor 26 may reference this list in order to determine whether or not utility consumption by that appliance (possibly when performing that function) should be discounted when determining the background level of consumption and may then ignore the contribution to the overall utility consumption due to that appliance accordingly (e.g. subtract the utility consumption attributable to that appliance from the utility values received at the step S302). This could be performed, for example, as part of the preprocessing step S304. Information regarding which appliances are being used at a particular time may be particularly beneficial when used in conjunction with the above series of moving averages, especially the case when n=1. In particular, for the case when n=1 (i.e. using the equation b_{new}=(1−α)b_{cur}+αp), being able to disregard a contribution from a known non-background function of an appliance means that the value of p can be adjusted to better reflect a current background utility value and hence the next background estimate, b_{new}, can be more accurately determined.

In one embodiment, the processor 26 may, based on a determined indication of the background level of consumption, effect a change in a state of an appliance consuming the utility. For example, the processor 26 may determine that the background level of consumption is greater than a predetermined threshold background level of consumption (this predetermined threshold may be e.g. a level set by a utility provider, a user-defined value, a value set by a regulator or any other value specifying a threshold of acceptable level of background consumption of a utility). The processor 26 may then detect which appliances are currently consuming the utility and based on a predetermined rule effect some change in the state of one or more of these appliances so as to try to reduce the background level of consumption.

If the processor 26 determines that the background level of consumption is greater than a threshold level, the processor 26 may analyse the received utility values to determine which appliances are currently consuming the utility. Based on the outcome of the determination the processor 26 may then cause one or more of the appliances to be switched off or paused. For example, the processor 26 may cause an immersion heater to be temporarily switched off until the background level of consumption returns to an acceptable level.

A list may be stored in the memory 28 specifying which appliances may be controlled/modified by the processor 26 if the background level of consumption exceeds a threshold level. For example a user may wish the heating to be switched off if the background level of electricity consumption exceeds a predetermined level, whilst the user may not wish the state of the fridge or freezer to be changed even if the background level of electricity consumption exceeds a predefined level.

Additionally, or alternatively, if the background level of consumption is determined to exceed a threshold level, then the apparatus 20 (e.g. via the output section 40) may output an alarm (or other warning indication) to a user, which may be an audible and/or visual alarm. This may be used to alert the user that there may be a possible fault with one or more of the appliances 12 (e.g. that a tap might be dripping or might have been left on, or that a thermostat on a heating system may be faulty and causing the heating to come on too often). The user may then take appropriate steps to effect a change in the state of an appliance (e.g. by turning off an appliance or mending or replacing the appliance).

It will be appreciated that embodiments of the invention may be implemented using a variety of different information processing systems. In particular, although FIG. 1 and the discussion thereof provide an exemplary system architecture, these are presented merely to provide a useful reference in discussing various aspects of the invention. Of course, the description of the architecture has been simplified for purposes of discussion, and it is just one of many different types of architecture that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1-30. (canceled)

31. A non-intrusive method of determining, in respect of a group of appliances that are arranged to consume a utility, an indication of a background level of consumption of the utility by the group of appliances, the method comprising:
receiving a series of utility values representative of a total level of consumption of the utility by the group of appliances;
identifying, based on the received utility values, an indication of a background level of consumption of the utility; and
outputting the identified indication of the background level of consumption of the utility;
wherein identifying an indication of a background level of consumption comprises:
calculating a series of moving averages from the received utility values; and
using the series of moving averages to determine the indication of the background level of consumption of the utility.

32. The method of claim 31, wherein calculating the series of moving averages is biased to respond more quickly to decreases in the received utility values than to increases in received utility values.

33. The method of claim 31, comprising calculating a next moving average x̅ₘ₊₁ according to x̅ₘ₊₁=(1−α) x̅ₘ+αp, where x̅ₘ is the most recently calculated moving average in the series of moving averages, p is a next received utility value and α is a value in the range 0<α<1.

34. The method of claim 33 comprising setting the value of α in dependence on the value of p.

35. The method of claim 34 in which:
$$α = \{ \begin{matrix}{α}_{1} & if p < ( b + c ) \\ {α}_{2} & if p \geq ( b + c )\end{matrix}$$
where b is a current indication of the background level of consumption and c is a predetermined value and α₁>α₂.

36. The method of claim 31, wherein using the series of moving averages to determine the indication of the background level of consumption of the utility comprises determining the background level of consumption of the utility to be a lowest moving average value from the series of moving averages.

37. The method of claim 31, wherein receiving a series of utility values comprises measuring, at multiple points in time, a total level of consumption of the utility by the group of appliances.

38. The method of claim 31, wherein receiving a series of utility values comprises receiving utility values over a period of time, the period of time being greater than an expected duration of usage of an appliance by a user of the appliance.

39. The method of claim 31, comprising providing a warning if the determined indication of the background level of consumption exceeds a predetermined threshold.

40. The method of claim 31, comprising:
using the received utility values to identify the operation of a particular appliance of the group of appliances;
wherein the step of identifying the indication of the background level of consumption of the utility is arranged such that the consumption of the utility by the particular appliance does not contribute to the indication of the background level of consumption of the utility.

41. The method of claim 31 wherein the utility is one of: electricity; gas; oil; or water.

42. A non-intrusive method of determining, in respect of a group of appliances that are arranged to consume a utility, an indication of a background level of consumption of the utility by the group of appliances, the method comprising:
receiving a series of utility values representative of a total level of consumption of the utility by the group of appliances;
identifying, based on the received utility values, an indication of a background level of consumption of the utility; and
outputting the identified indication of the background level of consumption of the utility;
wherein identifying an indication of a background level of consumption comprises determining a next indication of the background level of consumption based on a weighted sum of a current indication of the background level of consumption and a next received utility value.

43. The method of claim 42, wherein the weighted sum is biased to respond more quickly to decreases in the received utility values than to increases in received utility values.

44. The method of claim 42, wherein the weighted sum is calculated according to b_{new}=(1−α)b_{cur}+αp, where b_{new} is the next indication of the background level of consumption, b_{cur} is the current indication of the background level of consumption, p is the next received utility value and α is a value in the range 0<α<1.

45. The method of claim 44 comprising setting the value of α in dependence on the value of p.

46. The method of claim 15 in which:
$$α = \{ \begin{matrix}{α}_{1} & if p < ( {b}_{cur} + c ) \\ {α}_{2} & if p \geq ( {b}_{cur} + c )\end{matrix}$$
where c is a predetermined value and α₁>α₂.

47. The method of claim 42, wherein receiving a series of utility values comprises measuring, at multiple points in time, a total level of consumption of the utility by the group of appliances.

48. The method of claim 42, wherein receiving a series of utility values comprises receiving utility values over a period of time, the period of time being greater than an expected duration of usage of an appliance by a user of the appliance.

49. The method of claim 42, comprising providing a warning if the determined indication of the background level of consumption exceeds a predetermined threshold.

50. The method of claim 42, comprising:
using the received utility values to identify the operation of a particular appliance of the group of appliances;
wherein the step of identifying the indication of the background level of consumption of the utility is arranged such that the consumption of the utility by the particular appliance does not contribute to the indication of the background level of consumption of the utility.

51. The method of claim 42, wherein the utility is one of: electricity; gas; oil; or water.

52. A method of controlling consumption of a utility by a group of appliances arranged to consume the utility, the method comprising:
determining an indication of a background level of consumption of the utility by the group of appliances using a method according to claim 1; and
effecting, based on the determined indication of the background level of consumption of the utility, a change in a state of an appliance within the group of appliances so as to control a level of consumption of the utility by the appliance.

53. A method of controlling consumption of a utility by a group of appliances arranged to consume the utility, the method comprising:
determining an indication of a background level of consumption of the utility by the group of appliances using a method according to claim 12; and
effecting, based on the determined indication of the background level of consumption of the utility, a change in a state of an appliance within the group of appliances so as to control a level of consumption of the utility by the appliance.

54. An apparatus for non-intrusively determining, in respect of a group of appliances that are arranged to consume a utility, an indication of a background level of consumption of the utility by the group of appliances, the apparatus comprising a processor arranged to:
receive a series of utility values representative of a total level of consumption of the utility by the group of appliances;
identify, based on the received utility values, an indication of a background level of consumption of the utility; and
output the identified indication of the background level of consumption of the utility;
wherein the apparatus is arranged to identify the indication of a background level of consumption by: calculating a series of moving averages from the received utility values; and using the series of moving averages to determine the indication of the background level of consumption of the utility.

55. An apparatus for non-intrusively determining, in respect of a group of appliances that are arranged to consume a utility, an indication of a background level of consumption of the utility by the group of appliances, the apparatus comprising a processor arranged to:
receive a series of utility values representative of a total level of consumption of the utility by the group of appliances;
identify, based on the received utility values, an indication of a background level of consumption of the utility; and
output the identified indication of the background level of consumption of the utility;
wherein the apparatus is arranged to identify the indication of a background level of consumption by determining a next indication of the background level of consumption based on a weighted sum of a current indication of the background level of consumption and a next received utility value.
